(19) United States
(12) Patent Application Publication
(10) Pub. No.: US 2009/0088888 A1
(43) Pub. Date: Apr. 2, 2009

(54) COMPONENT MOUNTING METHOD

(76) Inventors: Takeyuki Kawase, Saga (JP); Yoshiyuki Hattori, Yamanashi (JP)

Correspondence Address: WENDEROTH, LIND & PONACK L.L.P., 2033 K. STREET, NW, SUITE 800, WASHINGTON, DC, 20006, US

(21) Appl. No.: 11/995,166

(22) PCT Filed: Aug. 7, 2006
(86) PCT No.: PCT/JP2006/315972

§ 371 Date: Jan. 9, 2008

(30) Foreign Application Priority Data
Aug. 22, 2005 (JP) 2005-239925

(51) Int. Cl. G06F 19/00; B23P 19/00

(52) U.S. Cl. 700/121; 29/739

(57) ABSTRACT

The component mounter (100) includes a component return determination apparatus (503) being a computer device for determining whether the electronic component picked up by a suction nozzle is a component to be returned to the component supply unit based on a component type. The component return determination apparatus (503) has: a data storage unit (506) into which pick-up position information (506a), the number of remaining components (506b), component return flag information (506c) are stored; a reuse judgment unit (507) which judges whether the electronic component currently picked up by the suction nozzle is the component to be returned to the component supply unit for reuse; and a component return control unit (508) which obtains pick-up position information of the picked-up component from the pick-up position information (506a) stored in the data storage unit (506) and controls an XY robot so that the component is returned to the pick-up position.

### TECHNICAL FIELD

The present invention relates to a component mounting method for allowing a component mounter, which mounts components such as electronic components onto a board, to return picked-up components to a component supply unit.

### BACKGROUND ART

Conventionally, in a component mounter for mounting electronic components onto a board, a disposal box for disposal of electronic components is provided for the disposal of the electronic components that are recognized as defective electronic components by a component recognition camera.

Furthermore, conventionally, at the time of component teaching for checking whether or not electric components picked up by suction nozzles can be correctly recognized by the component recognition camera, a mounting head picks up the electronic components supplied from a component supply unit such as a tray or a feeder; the picked-up components are checked by the recognition camera; and defective electronic components are disposed of in the disposal box.

In contrast to the aforementioned technology of disposing of the components, as a technology of returning the picked-up components to the component supply unit, there has been disclosed a component supply method for an axial component insertion machine which takes out components from a component case and returns the components to the component case by reversing the supply direction of polar components (e.g. refer to Patent Reference 1, Japanese Laid-Open Patent Application No. 62-293691).

Furthermore, there has been disclosed a processing method after a component mounting processing intermission for a component mounter to return already picked-up components to an original tray even after a series of component mounting operations is interrupted (e.g. refer to Patent Reference 2, Japanese Laid-Open Patent Application No. 1-59900).

However, in the case where the component is recognized at the time of component teaching and can be recognized as being in a normal state, or in the case where the component is to be disposed of in the disposal box due to misalignment of a pick-up position and the like during automatic production, the electronic component is sent to the disposal box, so that there is a problem that still usable electronic components are wasted. This disposal of electronic components becomes problematic particularly in the case of expensive electronic components such as a CPU and the like.

Furthermore, the patent references 1 and 2 disclose only to return the picked-up components to the component supply unit so that the components are returned to the component supply unit without being judged regarding whether or not they are reusable components.

### DISCLOSURE OF INVENTION

The present invention is conceived in view of the aforementioned conventional problems, and has as an object to provide a component mounting method for preventing wasteful disposal of components which are still reusable or which need to be reused, at the time of component teaching or automatic production.

In order to solve the conventional problems, the component mounting method according to the present invention is a component mounting method for use with a component mounter which mounts a component supplied from a component supply unit onto a board, in which the component mounting method includes: picking up the component from the component supply unit using a suction nozzle; moving the suction nozzle to a predetermined position; recognizing the component picked up by the suction nozzle, using a recognition unit; judging whether or not the recognized component is a component to be returned to the component supply unit for reuse; and controlling the moving so that the component is returned to the component supply unit, in the case where the component is judged as being the component to be returned.

Furthermore, the component mounting method according to the present invention further includes storing a pick-up position, in the component supply unit, at which the component is picked up by the suction nozzle. In the controlling, the moving is controlled so that the component is returned to the pick-up position as a return position of the component.

With such configuration, in the case where, in the aforementioned judging, the electronic component which is once picked up by the suction nozzle is judged as a component to be returned to the component return unit for reuse, the electronic component can be returned to an original pick-up position of the component supply unit, and the wasteful disposal of the component in the disposal box is prevented.

Furthermore, the judging in the component mounting method includes judging whether or not the component needs to be reused. The judging further includes judging whether or not the component can be reused.

With this configuration, it can be judged whether or not, for each component type, a component needs to be reused in the judging regarding component reuse necessity. Furthermore, it can be judged whether or not the component can be reused on a recognition screen shown at the time of component teaching or component mounting production in the judging of whether or not the component can be reused.

It should be noted that, in order to achieve the aforementioned object, the present invention can be also realized as a component mounter having characteristic steps of the component mounting method as units or as a program including all of those steps. Furthermore, such program is not only stored in a ROM installed in the component mounter but also can be distributed through a recording medium such as a CD-ROM and a communication network.

The component mounting method according to the present invention prevents the wasteful disposal of the component which is still usable or needs to be reused at the time of component teaching or automatic reproduction.

As further information about technical background to this application, the disclosure of Japanese Patent Application No. 2005-239925 filed on Aug. 22, 2005 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is an external oblique perspective diagram showing a component mounter according to the embodiment of the present invention, and inside of a portion of the component mounter;

FIG. 2 is a plane diagram showing a main internal configuration of the component mounter;

FIG. 3 is an oblique perspective diagram which schematically showing a positional relationship between the multi-head unit and the component supply unit which is made up of supply cassettes;

FIG. 4 is a reference diagram showing an example of an external view of the component mounter;

FIG. 5 is a block diagram showing a functional configuration of the component mounter including a functional configuration of a component return determination apparatus;

FIG. 6 is a diagram showing an example of details of mounting point data used for the component mounter;

FIG. 7 is a diagram showing an example of details of a component library used for the component mounter;

FIG. 8 are reference diagrams of a display unit of the component return determination apparatus shown in FIG. 5;

FIG. 9 is a flowchart showing an operation procedure at the time of component teaching (a feeder component) before the start of an automatic production process by the component mounter according to the present invention;

FIG. 10 is a flowchart showing an operation procedure at the time of component teaching (a tray component) before the start of an automatic production process by the component mounter according to the present invention;

FIG. 11 is a flowchart showing an operation procedure at the time of automatic production (a feeder component) of the component mounter according to the present invention;

FIG. 12 is a flowchart showing an operation procedure at the time of automatic production (a tray component) of the component mounter according to the present invention; and

FIG. 13 are diagrams respectively showing an external view of a motor-driven feeder and an external view of a tray that are component supply units in the component mounter of the present embodiment.

### BEST MODE FOR CARRYING OUT THE INVENTION

Hereinafter, the details of a component mounting method according to the present invention are described with references to drawings.

### Embodiment

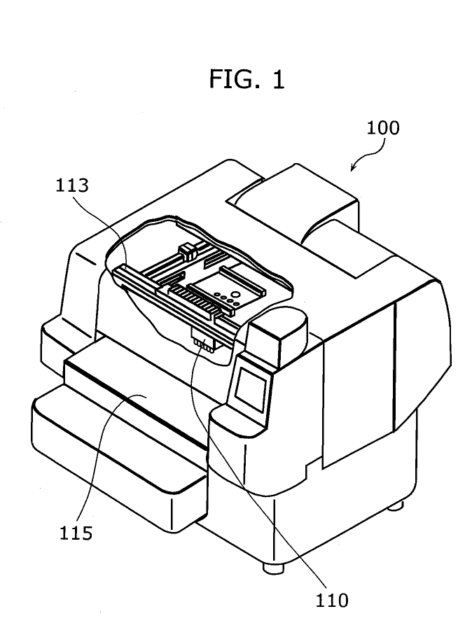

FIG. 1 is an external oblique perspective diagram showing a component mounter 100 according to the embodiment of the present invention, and inside of a portion of the component mounter 100. Note that, the component mounter 100 according to the present invention judges whether or not electronic components picked up by suction nozzles are reusable, and when judging the components as being reusable, can return the components to a component supply unit such as pick-up positions in a tray, pockets of an emboss feeder and the like, at the time of component teaching for checking of component recognition data or during automatic production of mounting the electronic components onto a board.

The component mounter 100 can be installed in a mounting line, and is a device which mounts electronic components received from upstream onto a board, and sends, toward downstream, a circuit board which is the board on which the electronic components have been mounted. The component mounter 100 includes suction nozzles for picking up electronic components in vacuum, a multi-head unit 110 having plural mounting heads capable of transporting the picked-up electronic components and mounting them onto a board, an XY robot 113 which causes the multi-head unit 110 to move toward a horizontal plane direction, and a component supply unit 115 which supplies the components to the mounting heads.

Specifically, this component mounter 100 is a component mounter capable of mounting electronic components which vary from fine components to a connector onto a board, and is a high speed multi-functional component mounter capable of mounting large electronic components with 10 mm square or greater, odd-shaped components such as switches/connectors, and IC components such as Quad Flat Package (QFP) and Ball Grid Array (BGA) and the like.

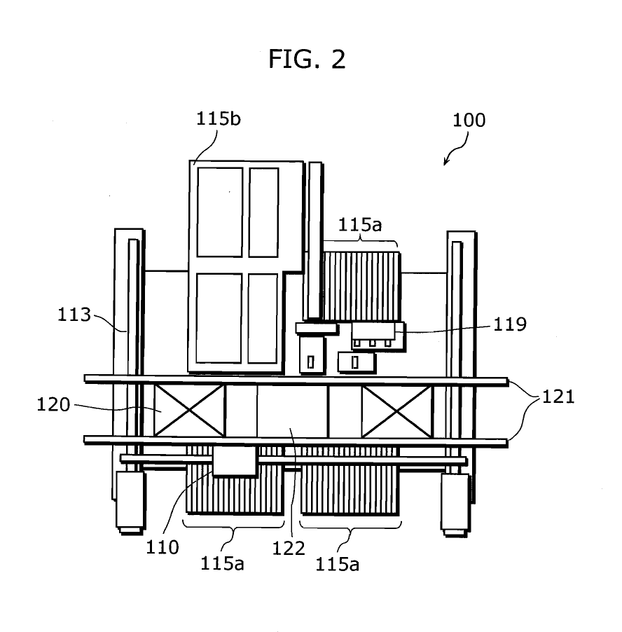

FIG. 2 shows a plane diagram showing main internal configuration of the component mounter 100.

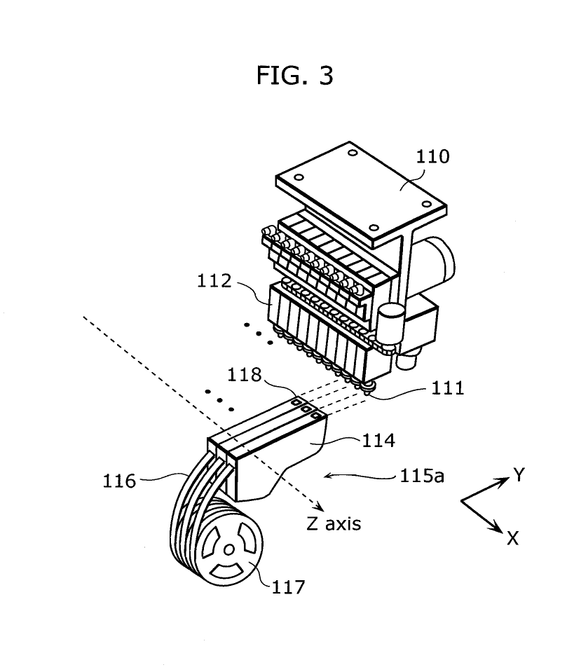

In order to correspond to component types of different shapes, the component mounter 100 further includes a nozzle station 119 in which a replacement suction nozzle which is freely replaceable to be equipped to mounting heads 112 (shown in FIG. 3) of the multi-head unit 110, and a rail 121 which constitutes a track for transporting the board 120, and a mounting table 122 on which the transported board 120 is placed and onto which electronic components are mounted.

Furthermore, the component supply units 115 are placed front and back of the component mounter 100, and include component supply units 115a having supply cassettes for supplying electronic components stored in a tape form, and a component supply units 115b for supplying electronic components stored in a plate on which partitions are placed according to a component size.

FIG. 3 is an oblique perspective diagram which schematically showing a positional relationship between the multi-head unit 110 and the component supply unit 115a made up of supply cassettes.

As shown in FIG. 3, the multi-head unit 110 includes plural mounting heads 112, and suction nozzles 111 are replaceably equipped to the tips of the mounting heads.

This multi-head unit 110 mounts electronic components onto the board 120 as follows. Specifically, in the case where a suction nozzle 111 equipped to the multi-head unit 110 does not match with an electronic component to be mounted next, the multi-head unit 110 is moved to the nozzle station 119 and the suction head 111 is replaced. Next, the multi-head unit 110 is moved to above the component supply unit 115a, and the respective mounting heads 112 are moved downward. Accordingly, the suction nozzles 111 equipped to the tips of the mounting heads 112 pass through a supply port 118 of a tape feeder 114 and pick Lip the electronic components. Then, the mounting heads 112 are moved upward; the electronic components being held with the multi-head unit 110 are transported to mounting positions above the board 120; the mounting heads 112 are moved downward; and the electronic components are mounted onto the board 120.

On the other hand, the supply cassettes of the component supply unit 115a shown in FIG. 3 includes component tapes 116 for storing plural electronic components of the same component type by aligning them onto a carrier tape, supply reels 117 for holding the component tapes 116 by winding them around, and tape feeders 114 for sending the component tapes 116 out from the supply reels 117 when necessary and exposing the electronic components to the supply port 118 in order to take the electronic components out from the component tapes 116.

In the case of present embodiment, in the component supply unit 115a, supply cassettes are aligned in a Z axis direction, individual supply cassette is replaced when necessary such as when there is a lack of components, and the component tapes 116 and the supply reels 117 can be replaced with each other.

Furthermore, as shown in FIG. 3, a component supply position of each supply cassette (specifically, which is a position determined by a suction nozzle at the time of picking up a component, and for example, it is a center position of the supplied component) is indicated by X and Y coordinates.

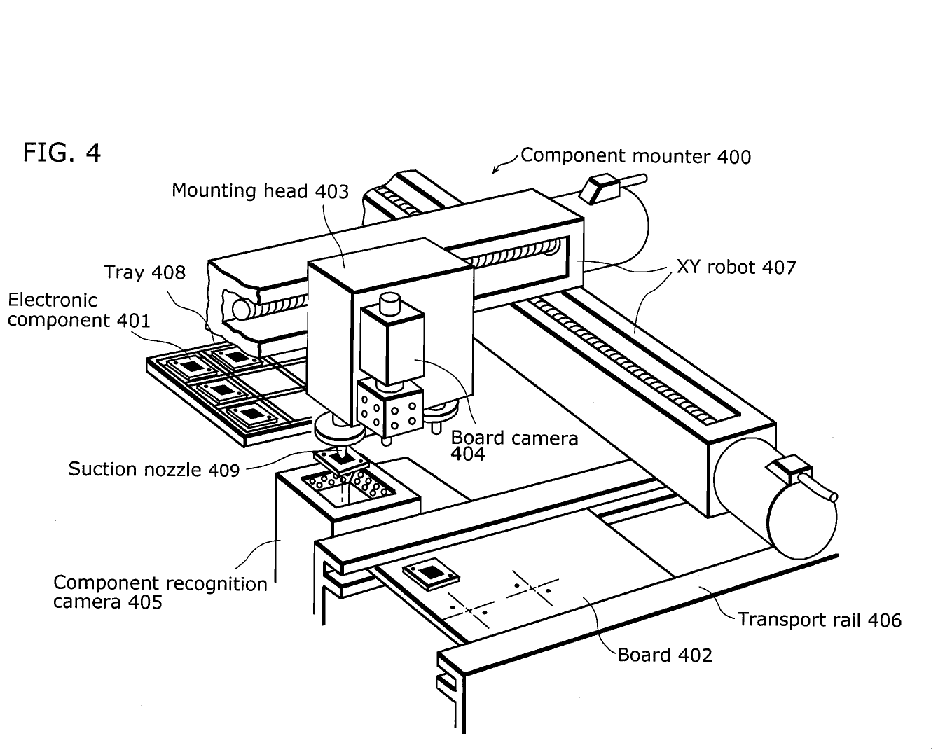

FIG. 4 shows a reference diagram showing an example of an external view of the component mounter 400. Here, the configuration of the component mounter which supplies components from a tray is explained with reference to FIG. 4 which shows more detailed configuration than those in FIG. 1 and FIG. 2. For convenience, the component mounter shown in FIG. 4 is described in here. However, the component mounter shown in FIG. 1 and FIG. 2 also has the same configuration and functions as shown in FIG. 4.

In this diagram, at the time of component mounting, the component mounter 400 includes an electronic component 401, a board 402, a mounting head 403, a board camera 404, a component recognition camera 405, a transport rail 406, an XY robot 407, a tray 408, and suction nozzles 409.

The XY robot 407 moves the mounting head 403 to above the tray 408 which is a component supply unit. The suction nozzle 409 equipped to the mounting head 403 then picks up an electronic component 401 and the component recognition camera 405 recognizes a position of the picked-up electronic component 401. Based on this recognition result, a misaligned position of the electronic component 401 is corrected in an X direction, a Y direction and a θ direction which is a rotation direction, and the corrected electronic component 401 is mounted onto the board 402.

The board camera 404 is used to recognize a mark placed on a corner of the board 402 for recognizing the board 402 and a target mark which is a board side mark for recognizing a mounting position. Also, the field of vision of the board camera 404 is for example 4 mm square.

The component recognition camera 405 recognizes a degree to which the electronic component 401 picked up by the suction nozzle 409 is misaligned. Based on the recognized degree of misalignment, the XY robot 407 corrects the misaligned position of the electronic component 40 in an X direction and a Y direction while the mounting head 403 corrects the misaligned position of the electronic component 40 in a θ direction that is a rotation direction. Furthermore, the component recognition camera 405 also recognizes a lead misalignment and the like that are other defective items which occur when an electronic component is picked up.

The transport rail 406 is a guiding means in the case where the board 402 is transported to a position at which mounting processing is to be performed, using a transport belt and a transport arm for example.

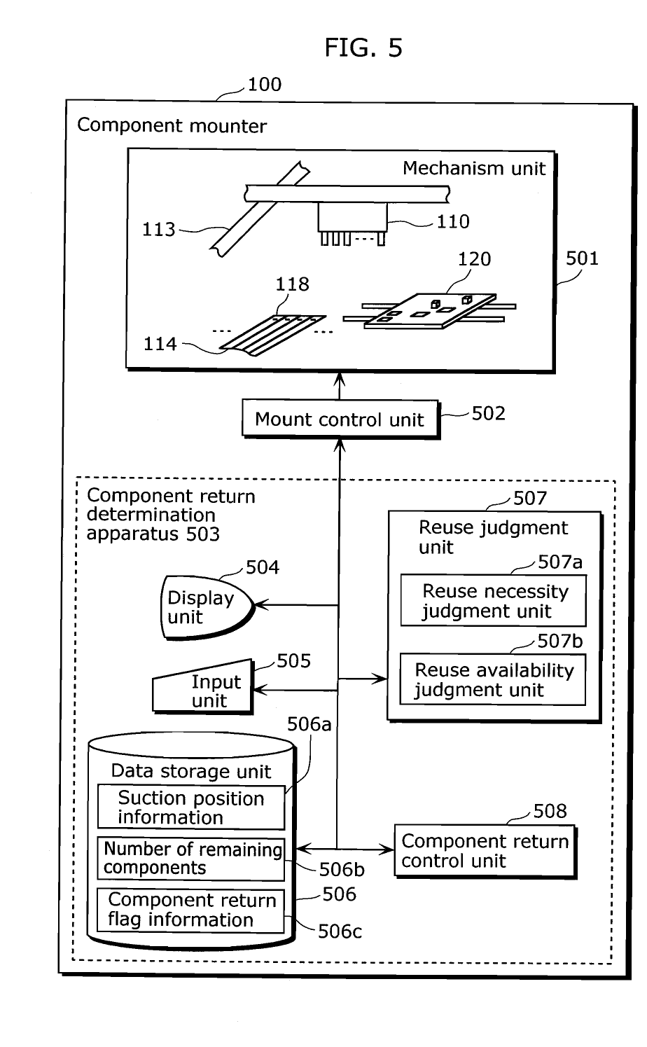

The XY robot 407 is a robot which moves two-dimensionally, and is activated, for example, based on a mounting program recorded in a data storage unit 506 (refer to FIG. 5) which shall be described later. Furthermore, the XY robot 407 moves the mounting head 403 to a predetermined pick-up position on the tray 408, and moves the mounting head 403 to an original pick-up position on the tray 408 in the case where it is judged that a current electronic component is a component to be returned.

The tray 408 is placed in the component supply unit, on which electronic components 401 to be mounted onto the board 402 are aligned.

FIG. 5 is a block diagram showing functional constituents of the component mounter 100 including functional constituents of the component return determination apparatus 503.

The component return determination apparatus 503 shown in this diagram is a computer device which determines whether or not an electronic component already picked up by the suction nozzle is an electronic component to be returned to the component supply unit, based on a component type and the like. The component return determination apparatus 503 includes a display unit 504, an input unit 505, a data storage unit 506, a reuse judgment unit 507, and a component return control unit 508.

The component mounter 100 further includes a mechanism unit 501 which functions as a component mounting unit, and a mount control unit 502 which controls the mechanism unit 50 based on a result determined by the component return determination apparatus 503.

The display unit 504 is a Cathode-Ray Tube (CRT), a Liquid Crystal Display (LCD) and the like, and the input unit 505 is a keyboard, a mouse, a touch panel and the like. They are used for inputting data for controlling the component mounter 100 in addition to a target production time, the number of the boards 120 to be produced in that production time and the like that are resultants of discussions between the component mounter 100 and an operator.

The data storage unit 506 is a storage apparatus such as a hard disc drive, in which pick-up position information 506a, the remaining number of components 506b, component return flag information 506c and the like are stored. The pick-up position information 506a shows a position in the component supply unit at which a component is picked up by the suction nozzle at the time of component checking or automatic production. It records values of X and Y coordinates of the pick-Lip position based on an origin point on the X and Y coordinates system shown in FIG. 3 and a value of height of the pick-up position. The remaining number of components 506b is the remaining number of components stored in each supply cassette. The component return flag information 506c is shown as “ON” when a reuse necessity judgment unit 507a (this shall be explained later) judges that the component needs to be reused for each component type.

Furthermore, in the component mounter 100 according to the present invention, it is necessary to manage the number of remaining components for performing a process of adding one to the number of remaining components 506b, in the case where a component is to be returned. Note that, Numeric Control (NC) data such as mounting order and the like is also stored in this data storage unit 205. This NC data is data relating to a mounting order, a mounting point and the like of an electronic component calculated based on each database. Furthermore, the pick-up position information 506a includes, for each electronic component to be picked up, an X coordinate, a Y coordinate and height information.

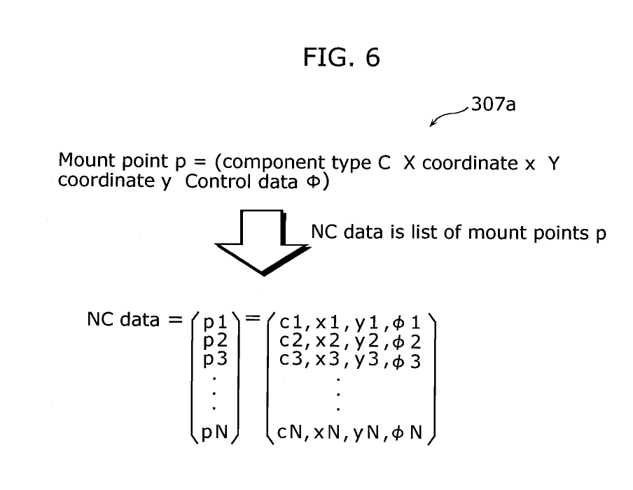

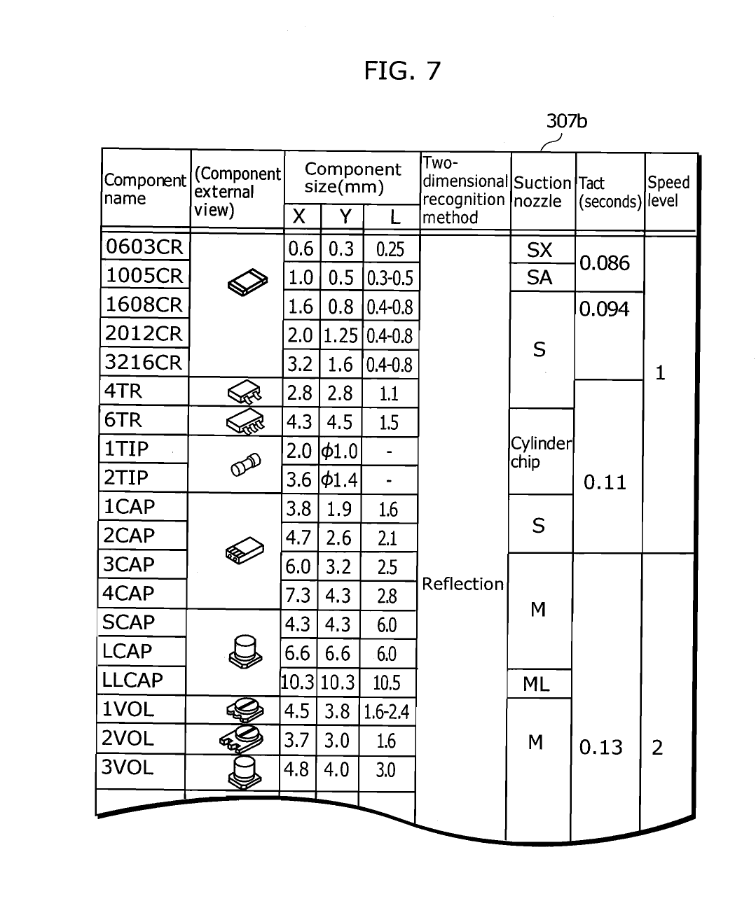

FIG. 6 and FIG. 7 are explanation diagrams of NC data, respectively showing an example of mounting point data 307a and a component library 307b.

The mounting point data 307a is a collection of pieces of information indicating mounting points of all the components to be mounted. As shown in FIG. 6, one mounting point pi is made up of a component type ci, an X coordinate xi, a Y coordinate yi, and control data Φi. Here, a “component type” corresponds to a component name in the component library 307b; an “X coordinate” and a “Y coordinate” are coordinates of a mounting point (coordinates indicating a specific position on the board); and “control data” is restriction information (a type of available suction nozzle, the speed level of the multi-mounting head 112, and the like) regarding mounting of the component. It should be noted that, final NC data to be obtained is an arrangement of mounting points with which minimum line tact is obtained.

The component library 307b is a library in which unique information for each of all the component types that can be dealt with the component mounter 100 is collected. As shown in FIG. 7, it includes, for each component type, a component size, a tact (a tact unique to a component type under a predetermined condition), and other restriction information (a type of available suction nozzle, a recognition method for the component recognition camera 405, the speed level of the multi-mounting head and the like). In this diagram, an external view of a component of each component type is also shown as a reference. The component library may also include information such as a color and shape of a component.

The reuse judgment unit 507 judges whether or not an electronic component recognized by the component recognition camera is to be reused. This judgment of whether or not an electronic component currently being picked up by a suction nozzle is a component to be reused is made by judging whether or not a type of the electronic component recognized by the component recognition camera matches with a reusable component that is already set by an input from an operator or the like.

Furthermore, the reuse judgment unit 507 includes a reuse necessity judgment unit 507a and a reuse availability judgment unit 507b. The reuse necessity judgment unit 507a judges whether or not the electronic component recognized by the component recognition camera is a component which needs to be reused. The reuse availability judgment unit 507b judges whether or not the electronic component recognized by the component recognition camera is a component which can be reused.

In the reuse necessity judgment unit 507a, the method of judging whether or not a current electronic component needs to be reused is realized by judging whether or not the current electronic component matches with the component which needs to be reused that is previously set by an input from an operator or the like. Here, the aforementioned setting does not need to be set by an operator, but may be originally stored in the data storage unit 506.

The judgment of whether or not the component can be reused by the reuse availability judgment unit 507b is realized based on an image of a recognized component. Furthermore, as similar to the case of judgment on reuse necessity, in the case where it has been known that a current component type can probably be reused, the judgment of reuse availability may be realized by judging whether or not the current component type matches with the previously set component which can be used.

It should be noted that, the judgment of whether or not a current component is to be reused by the reuse judgment unit 507 is realized not only by the aforementioned example of judgments of reuse necessity by the reuse necessity judgment unit 507a and of reuse availability by the reuse availability judgment unit 507b.

In the case where the reuse judgment unit 507 judges that a current electronic component is an electronic component to be reused, the component return control unit 508 obtains pick-up position information of a currently picked-up component from the pick-up position information 506a stored in the data storage unit 506, and controls the XY robot which is a transportation means for suction nozzles so as to return the electronic component to the pick-up position.

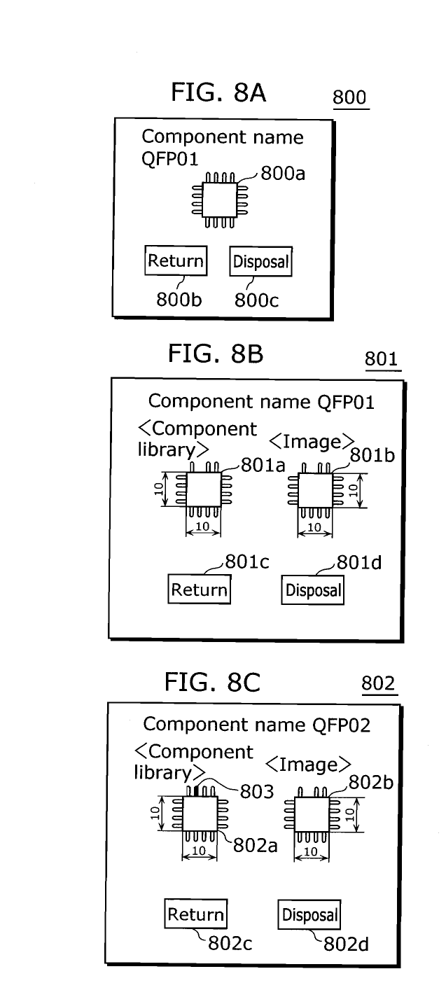

FIG. 8 is a reference diagram of the display unit 504 of the component return determination apparatus 503 shown in FIG. 5.

FIG. 8A is an operation screen 800 on which, for each component type, a return or disposal of a current component displayed on the screen is selected. On the screen 800, a graphic component image 800a drawn based on component dimension data in the component library is displayed.

Furthermore, based on the selection details, the reuse determination unit 507 of the component mounter can judge whether or not the current component is a component to be reused (reuse necessary, reuse available).

On this screen 800, if the “return (800b)” button is pressed, the current component is to be returned to a feeder or a tray after being through component teaching or recognition error at the time of automatic mounting. If the “disposal (800c)” button is pressed, the current component is to be disposed of to a disposal box after being through component teaching or recognition error at the time of automatic mounting.

Specifically, in the case where the operator considers that the component is expensive so that it should be reused after the component teaching, the operator presses the “return (800b)” button. Also, in the case where the operator considers that the component is unlikely to cause defectives such as lead curves so that the component can be reused after the component teaching, the operator presses the “return (800b)” button.

Here, the component teaching indicates checking whether or not a component which is newly mounted can be correctly recognized by actually recognizing it before the mounting production. For a mounting production, data of the component such as its dimension is inputted in the component library. However, in reality, it is necessary to perform component teaching in order to actually recognize and check whether or not a current component is the same as the component shown by the dimension data inputted in the component library.

FIG. 8B shows an operation screen 801 (an operation screen for selecting whether or not a current component can be reused) on which, after a component is checked, a return or disposal of the checked component is selected On the screen 801, a graphic component image 801a drawn based on component dimension data in the component library and a recognized image 801b of the same component captured are arranged and displayed.

The operator looks at the recognized image 801b, presses the “return (801c)” button when considering that the displayed component can be reused, and presses the “disposal” (801d) button when considering that the displayed component cannot be reused.

Note that whereas, in the aforementioned explanation, the “return (801c)” button or the “disposal (801d)” button is pressed based on the result judged by the operator, the selection may be made automatically that the component can be reused if the graphic component image 801a in the component library matches with the recognized image 801b.

Furthermore, FIG. 8C shows an operation screen 802 (an operation screen for selecting whether or not a current component can be reused) on which, when a component recognition error occurs, a return or disposal of the recognized component is selected. On the screen 802, a graphic component image 802a drawn based on component dimension data and the like in the component library and a recognized image 802b of the same component captured are arranged and displayed.

The operator then compares the graphic image 802a in the component library with the recognized image 802b, and when determining that the recognition error did not cause the defective of the picked-up component, presses the “return (802c)” button considering the component as being usable. On the recognized image 802b in FIG. 8C, a lead 803 which does not actually exist in the component library is inputted in the graphic component image 802a in the component library so that the recognized image 802b does not match with the graphic component image 802a in the component library causing a recognition error. In this case, the component itself does not have problems so that it can be reused.

Furthermore, the operator compares the graphic component image 802a in the component library with the recognized image 802b, and presses the “disposal (802d)” button if the recognition error is caused by the defectives of the component.

Note that, even in the case where component teaching is not successfully performed due to recognition errors, a return of a component is performed by selecting the “return” using the disposal method.

Accordingly, the component mounter according to the present invention can set so as not to wastefully dispose of electronic components by selecting “return” for the electronic components for which defectives such as lead curves and the like are unlikely to be generated.

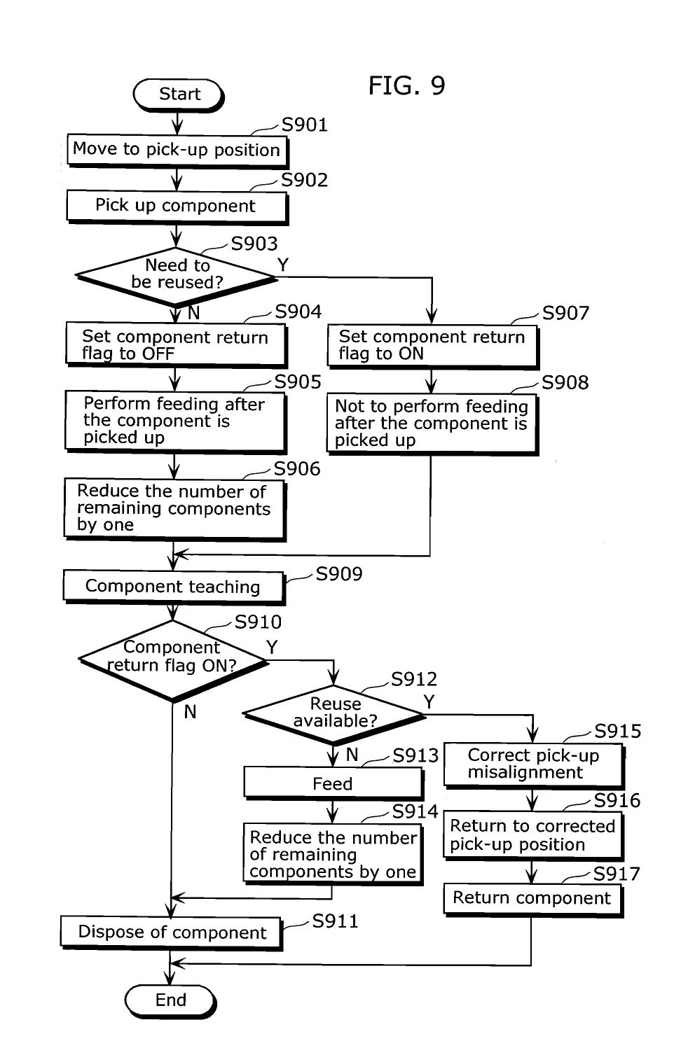

FIG. 9 is a flowchart showing an operation procedure at the time of which the component mounter 100 performs checking of a component (a feeder component) before the start of automatic production process.

First, a suction nozzle is moved to a position at which an electronic component in a feeder, which is a component supply unit, is to be picked up (S901).

Next, the component is picked up from the feeder by the suction nozzle (S902).

The reuse necessity judgment unit 507a judges whether or not the picked-up electronic component needs to be reused (S903).

Furthermore, when the reuse necessity judgment unit 507a judges that the current component needs to be reused (Y in S903), the component return flag is set to “ON” (S907); component feeding is not performed (S908); and a component teaching process, which is the process of judging whether or not the component can be correctly recognized, is performed (S909).

On the other hand, when the reuse necessity judgment unit 507a judges that the current component does not need to be reused (N in S903), the component return flag is set to “OFF” (S904); component feeding is performed after the current component is picked up (S905); a process of reducing the number of remaining components stored in the data storage unit 506 by one is performed (S906); and a component teaching process is performed (S909).

Next, by judging whether or not the component return flag is “ON” (S910), if the component return flag is “ON” (Y in S910), the reuse availability judgment unit 507b judges whether or not the current electronic component can be reused (S912).

In the case where the reuse availability judgment unit 507b judges that the current electronic component can be reused (Y in S912), the component return control unit 508 obtains, from the data storage unit 506, pick-up position information 506a of the currently picked-up electronic component at the original component supply unit, and corrects the degree of misalignment of the pick-up position obtained from the recognized image of the picked-up component, based on the pick-up position information 506a (S915); the currently picked-up electronic component is moved to the corrected pick-up position (S916); and the component is then returned (S917).

On the other hand, in the case where the reuse availability judgment unit judges that the current electronic component cannot be reused (N in S912), component feeding is performed (S913); the number of remaining components is reduced by one (S914); and the disposal of the current component is then performed (S911).

Furthermore, in the case where the component return flag is not “ON” (N in S910), the component, which has been checked, is disposed of to the disposal box (S911) and the series of processes is terminated.

As described in the above, in the operations of component teaching by the component mounter according to the present invention, the reuse necessity judgment unit 507a judges whether or not an electronic component needs to be reused, and when it is judged that the electronic component needs to be reused, the reuse availability judgment unit 507b judges that the electronic component can be reused.

The “judgment on reuse necessity” by the reuse necessity judgment unit 507a is made based on the inputted result shown in FIG. 8A (for example, the data inputted on the screen of FIG. 8A has been stored as one item in the component library), and for the “judgment on reuse availability” by the reuse availability judgment unit 507b, it is judged that the electronic component can be reused when the operator presses the “return” button on the screen of FIG. 8B.

Note that, whereas, in the description of this diagram, feeding is performed when it is clearly determined that the current component is not to be returned as shown in S905, the timing of feeding is not restricted to this. The feeding may be performed after a component is picked up, and performed again in a reverse direction when it is clearly determined that the component is to be returned.

Further, whereas, in this diagram, the number of remaining components is reduced by one when it is clearly determined that the component is not to be returned, the timing of reduction is not restricted to this. The number of remaining components may be reduced by one after the component is picked up, and increased to one when it is clearly determined that the component is to be returned.

Also, whereas, in this diagram, two levels of judgments, which are reuse necessity judgment by the reuse necessity judgment unit 507a and reuse availability judgment by the reuse availability judgment unit 507b, are performed, one of the two judgments may be omitted.

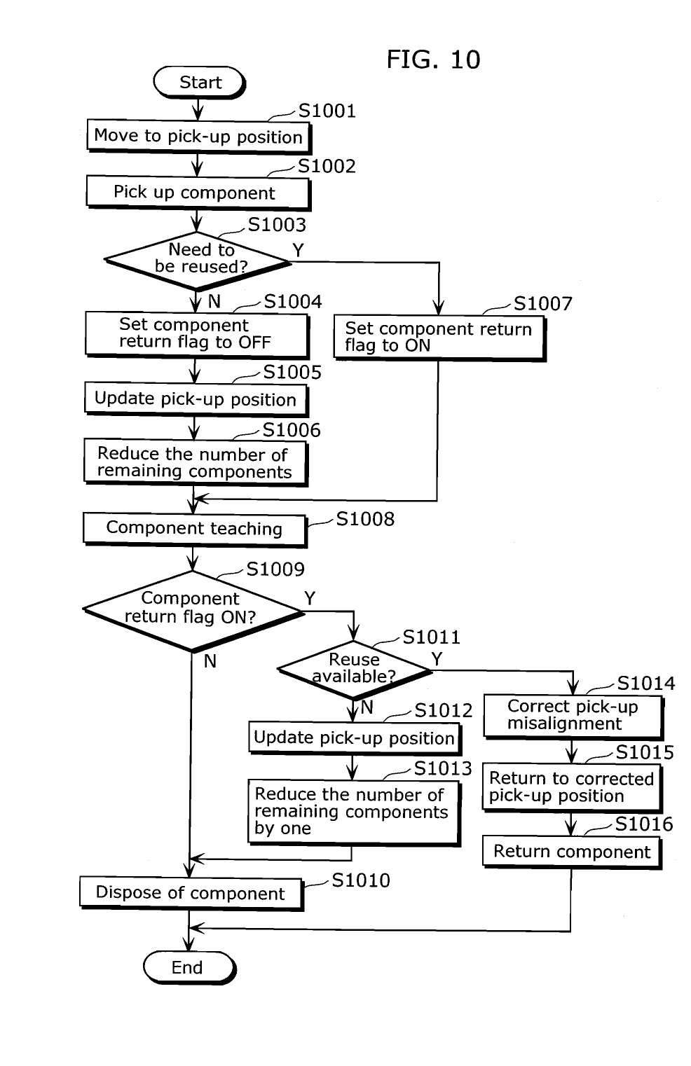

FIG. 10 is a flowchart showing an operation procedure at the time of which the component mounter 100 performs checking of a component (a tray component) before the start of automatic production process. Note that, in the case of the tray component, an electronic component is supplied from a tray, which is a component supply unit. In S1005 and S1013, instead of feeding operations in S905 and S913 of feeder components shown in FIG. 9, a position at which the electronic component is picked up is recorded into the data storage unit 506 when the component is picked up, and the position is updated to the next pick-up position and the updated position is stored in the case where the component is not reused.

Furthermore, as described in the above, “the pick-up position update (S1005, S1012)” is an operation equivalent to “feeding” of the feeder, and data is updated to a pick-up position in a section of a next component to be picked up after the current component is picked up. However, the position at which the next component is to be picked up may be specified based on the number of remaining components. In this case, an order of positions at which electronic components are subsequently picked up has been determined (e.g. adjacent components are sequentially taken out from the back of the component supply unit in order to prevent the components from being randomly taken out) and it is prerequisite that the electronic components are taken out in that order. Furthermore, in the case of returning a component, it is a prerequisite to return the component to the position at which said component was picked up.

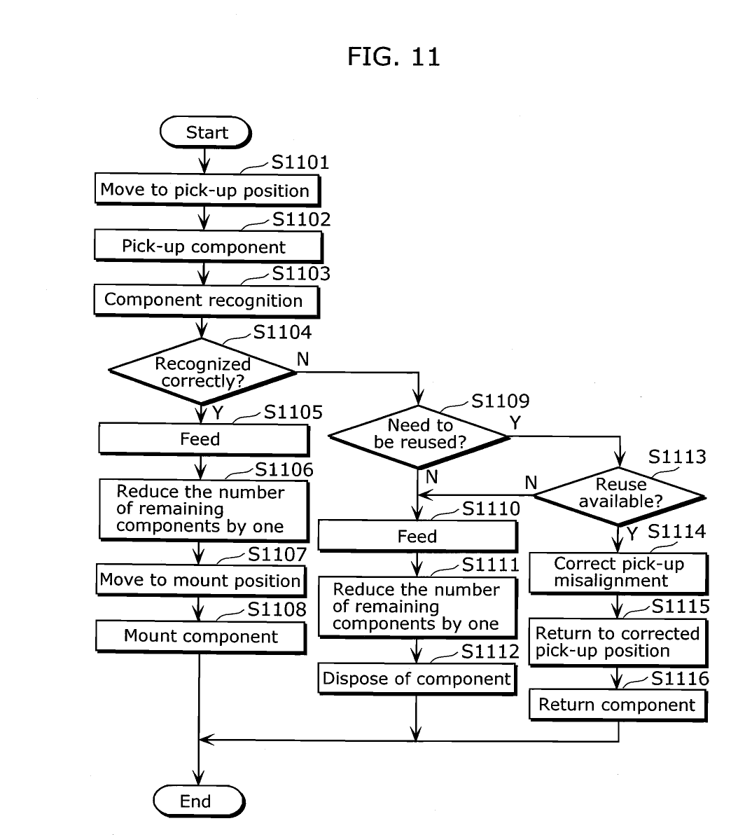

FIG. 11 is a flowchart showing an operation procedure at the time of automatic production (a feeder component) by the component mounter 100 according to the present invention.

First, a suction nozzle is moved to a position at which a component is picked up (S101).

Next, a current electronic component supplied from a feeder is picked up by the suction nozzle (S1102), is recognized by the component recognition camera (S1103), and is judged whether or not being correctly recognized without positional misalignment or defectives such as lead curves (S1104).

In the case where the electronic component is correctly recognized without defectives (Y in S1104), component feeding is performed (S1105); the number of remaining components 506b stored in the data storage unit 506 is reduced by one (S1106); the current electronic component is moved to a mounting position on a board (S1107) and is mounted (S1108).

On the other hand, in the case where the current electronic component is not correctly recognized because defectives are found (N in S1104), the reuse necessity judgment unit 507a judges whether or not the current electronic component needs to be reused (S1109), and when the current electronic component needs to be reused (Y in S1109), the reuse availability judgment unit 507b judges whether or not the current electronic component can be reused (S1113).

In the case where the reuse availability judgment unit 507b judges that the current electronic component can be reused (Y in S1113), the component return control unit 508 obtains, from the data storage unit 506, pick-up position information 506a of the current electronic component, which is currently being picked-up, of the original component supply unit, and corrects, based on the pick-up position information 506a, the degree of misalignment of the picked-up component obtained from the recognized image (S1114). The current electronic component is then returned to the corrected pick-up position (S1115), and returned to the feeder (S1116).

Furthermore, in the case where the reuse availability judgment unit 507b judges that the current electronic component cannot be reused (N in S1113), component feeding is performed (S1110); the number of remaining components 506b stored in the data storage unit 506 is reduced by one (S1111); the disposal of the current component is then performed (S1112).

Furthermore, in the case where the reuse necessity judgment unit 507a judges that the current electronic component does not need to be reused (N in S1109), component feeding is performed (S1110); the number of remaining components is reduced by one (S1111); the disposal of the current component is then performed (S1112).

Note that, also in this diagram, the reuse necessity judgment unit 507a judges whether or not an electronic component needs to be reused, and the reuse availability judgment unit 507b judges that the electronic component can be reused.

The judgment of reuse necessity by the reuse necessity judgment unit 507a is made based on the inputted result shown in FIG. 8A (for example, the data inputted on the screen of FIG. 8A is stored as one item in the component library), and the judgment of reuse availability by the reuse availability judgment unit 507b is judged that the electronic component can be reused when an operator presses the “return 802c” button on the screen of FIG. 8C.

Furthermore, the additional explanation about the reduction of the number of components by one is the same as the explanation shown in FIG. 9.

As similar to the above case, whereas in this diagram, two levels of judgments which are the reuse necessity judgment by the reuse necessity judgment 507a and the reuse availability judgment by the reuse availability judgment unit 507b are performed, one of the judgments may be omitted.

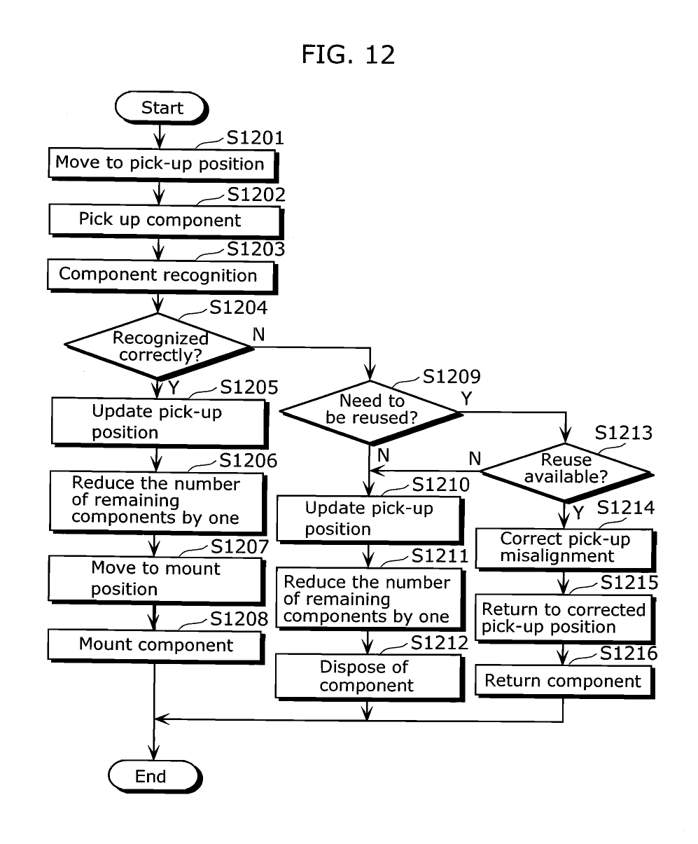

FIG. 12 is a flowchart showing an operation procedure at the time of automatic production (a tray component) by the component mounter 100 according to the present invention. Note that, in the case of the tray component, an electronic component is supplied from a tray which is a component supply unit, a process of updating the position of the tray at which the electronic component is picked up which is stored in the data storage unit 506 is performed in S1205 and S1210 instead of feeding operation performed on the feeder component in S1105 and S1110 shown in FIG. 11.

Furthermore, the additional explanation about the pick-up position update in the case of a tray is the same as the explanation shown in FIG. 10.

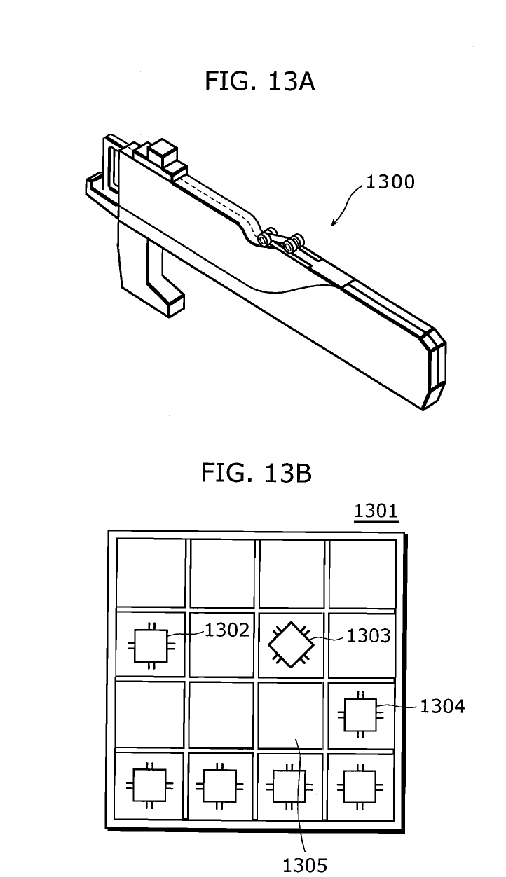

FIG. 13 are diagrams showing external views of a motor-driven feeder 1300 and a tray 1301 that are component supply units in the component mounter of the present embodiment. Here, the motor-driven feeder 1300 and the tray 1301 shown in FIG. 13 are examples and the component supply unit is not restricted to the examples shown in FIG. 13.

FIG. 13A is a diagram showing an external view of the motor-driven (self-running) feeder 1300. In this motor-driven feeder 1300, tape feeding is driven by a servomotor and feeding pitch/feeding speed is set in accordance with a component.

Furthermore, FIG. 13B shows a plane diagram of the tray 1301. In this diagram, mounting processes have been performed on up to the position 1305 which is a position immediately before the position of an electronic component 1304, for example, and an electronic component 1302 is an electronic component judged as reusable in S1113 of FIG. 13 and returned to the tray 1301. Note that, for example, it is considerable to return the electronic component by rotating with a predetermined angle shown as the electric component 1303 when the electronic component is returned in accordance with a type of defective of the electronic component.

As described above, in the component mounter 100 according to the present invention, the pick-up position information 506a at the time of which the suction nozzle picks up an electronic component is stored into the data storage unit 506, and when the reuse judgment unit 507 judges that the electronic component is a component to be reused, the component is returned to a component supply unit such as a tray as a returning position that is the pick-up position so that the wasteful disposal of the electronic component can be prevented.

Furthermore, the electronic component that is judged as recognition error at the time of automatic production can be returned to an original position of the component supplier such as a tray, a feeder and the like. Accordingly, component points and the amount of control can be reduced and the electronic components can be safely collected to the component supply unit, omitting the constituent elements of a return plate unit, a base for setting the return plate unit, and a disposal box.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The component mounting method according to the present invention can be used as a component mounting method for a component mounter such as a chip mounter, and is particularly applicable to the method of returning an electronic component picked up by a suction nozzle to the component supply unit in a mounter for mounting various types of electronic components.

1. A component mounting method for use with a component mounter which mounts a component supplied from a component supply unit onto a board, said method comprising:
picking up the component from the component supply unit using a suction nozzle;
moving the suction nozzle to a predetermined position;
recognizing the component picked up by the suction nozzle, using a recognition unit;
judging whether or not the recognized component is a component to be returned to the component supply unit for reuse; and
controlling said moving so that the component is returned to the component supply unit, in the case where the component is judged as being the component to be returned.

2. The component mounting method according to claim 1 further comprising
storing a pick-up position, in the component supply unit, at which the component is picked up by the suction nozzle,
wherein in said controlling, said moving is controlled so that the component is returned to the pick-up position as a return position of the component.

3. The component mounting method according to claim 1,
wherein in the case where a positional misalignment of the component is recognized in said recognizing, said moving is controlled so that a degree to which the component is misaligned is corrected and the component is returned to the component supply unit.

4. The component mounting method according to claim 1,
wherein in said judging, in the case where the component is recognized as being in a normal state in said recognizing, the component is judged as being the component to be returned.

5. The component mounting method according to claim 1,
wherein said judging includes judging whether or not the component needs to be reused.

6. The component mounting method according to claim 1,
wherein said judging includes judging whether or not the component can be reused.

7. The component mounting method according to claim 5,
wherein in said judging of whether or not the component needs to be reused, it is judged whether or not the component needs to be reused, based on a content which is previously set for each component type.

8. The component mounting method according to claim 6,
wherein in said judging of whether or not the component can be reused, it is judged whether or not the component can be reused, based on a component recognition image of a component which has been checked.

9. The component mounting method according to claim 6,
wherein in said judging of whether or not the component can be reused, it is judged whether or not the component can be reused, based on a component recognition image, in the case where recognition error occurs at a time of component mounting production.

10. The component mounting method according to claim 1,
wherein said judging includes:
judging whether or not the component needs to be reused; and
judging whether or not the component can be reused,
wherein in said judging of whether or not the component can be reused, it is judged whether or not the component, which is judged as being a component necessary to be reused in said judging of whether or not the component needs to be reused, can be reused.

11. The component mounting method according to claim 1,
wherein the component supply unit is a feeder, and
the feeder does not perform a feeding operation in the case where the component is picked up in said picking up and is judged as being the component to be returned for reuse in said judging.

12. The component mounting method according to claim 1,
wherein the component supply unit is a feeder, and
the feeder performs a reverse feeding operation in the case where the component, which is judged as being the component to be returned for reuse in said judging, is returned when the feeder performs a feeding operation after the component is picked up in said picking up.

13. A component mounter which mounts a component supplied from a component supply unit onto a board, said component mounter comprising:
a pick-up unit operable to pick up the component from the component supply unit using a suction nozzle;
a nozzle moving unit operable to move said suction nozzle to a predetermined position;
a recognition unit operable to recognize the component picked up by said suction nozzle;
a judgment unit operable to judge whether or not the recognized component is a component to be returned to said component supply unit for reuse; and
a control unit operable to control said nozzle moving unit so that the component is returned to said component supply unit, in the case where the component is judged as being the component to be returned.

14. A program for causing a computer to execute the component mounting method according to claim 1.
